(19) United States
(12) Patent Application Publication
(10) Pub. No.: US 2005/0068874 A1
(43) Pub. Date: Mar. 31, 2005

(54) Record carrier

(76) Inventors: Jacobus Petrus Josephus Heemskerk, Eindhoven (NL); Jakob Gerrit Nijboer, Eindhoven (NL); Ludovicus Marinus Gerardus Maria Tolhuizen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,828

(22) PCT Filed: Dec. 11, 2002
(86) PCT No.: PCT/IB02/05346

(30) Foreign Application Priority Data
Jan. 22, 2002 (EP) 02075254.9

(51) Int. Cl. G11B 5/09

(52) U.S. Cl. 369/59.23; 369/59.25

(57) ABSTRACT

P=X¹⁴+X¹²+X¹¹+X¹⁰+X⁴+X³+X²+1 The present invention relates to a record carrier for storing information according to a standardized format. The record carrier comprising address information comprising address data bits indicating a position on the record carrier, the address data bits being arranged according to the standardized format, and error-protection parity bits for detecting errors in the address data. The error-protection parity bits deviate from the error-protection parity bits according to the standardized format. The invention further relates to a device for reading out the record carrier according to the invention.

The invention relates to a record carrier for storing information according to a standardized format, the record carrier comprising address information comprising address data bits indicating a position on the record carrier, the address data bits being arranged according to the standardized format, and error-protection parity bits for detecting errors in the address data.

The invention further relates to a device for storing information on the record carrier, comprising reading means for reading the address data bits and the error-protection parity bits present on the record carrier, error-correction means for detecting errors in the address information and writing means for storing information on the record carrier.

Recordable—or rewritable—types of record carriers are well known, e.g. the standardized recordable compact discs (CD-R discs) or the rewritable compact discs (CD-RW discs). These record carriers are provided with information in a recording device by writing information signals in a preformed track consecutively or random at selected locations. CD-R discs for example are used for various applications, e.g. for consumer audio recorders (stand-alone devices) and for not-specified, general applications. CD-R discs for use in consumer audio recorders are sometimes called audio CD-R discs and CD-R discs for use in not-specified, general applications are sometimes called data CD-R discs.

The consumer audio recorders for recording audio CD-R discs refuse to record audio information on data CD-R discs. The reason is that it was expected initially that in many countries an audio levy would be set on audio CD-R discs only. A levy is remuneration paid by manufacturers and importers of blank audio recording media for the recording of a musical work onto an audio recording medium for own private use. This remuneration is for those who own the rights associated to those musical works (composers, authors, performers and producers).

In the reality of the current market, most CD recorders are used as a PC peripheral and these optical disc drives accept all types of CD-R discs for recording, irrespective of the application. Recently, an audio levy has also been set on blank data CD-R discs in many countries. The rationale being that PC drives are often used for copying audio CD's or for free downloading from music sites on Internet.

A lot of effort in Research & Development and in marketing is carried out in developing music sites that are under control by the music companies, and where music can be downloaded against proper payment. The Internet is then an independent distribution channel for selling music. The music sold is usually compressed audio, compressed according to one of the popular compression algorithms, like e.g. MP3, AAC or WMA. The downloading can be done to different storage media, removable or non-removable. Obviously, one of the removable storage media of interest is CD-R.

A secure recorder will have a number of provisions to identify itself to the application program as a secure device (e.g. as defined by agreements between content industry, the music companies, and hardware industry), and it will write on the disc in a secure way. Commonly available solutions are: an encrypted interface for secure authentication of drive and application, or encrypted data stored on the disc to block read-out by a non-secure device.

European patent application EP 1 081 698 A2 discloses a record carrier comprising pre-recorded address data on which digital data is recorded. Part of the pre-recorded address data is stored on the record carrier after being converted in accordance with a pre-set conversion rule, instead of being sequentially recorded on the record carrier in an incrementing order. Using this record carrier illicit copying of musical works can be prevented. This record carrier has as a disadvantage that, due to the fact that the pre-recorded address data are converted before being stored on the record carrier, the pre-recorded address data are not in synchronism with the digital data.

It is an object of the present invention to provide a record carrier which does not support illicit copying of musical works. This object is achieved by a record carrier wherein the error-protection parity bits deviate from the error-protection parity bits according to the standardized format.

By making the error-protection parity bits deviate from the error-protection parity bits according to the standardized format, a record carrier is realized which can only be used in a modified recorder. Currently available recorders can not use this record carrier as the error-protection parity bits present on the record carrier are not correctly interpreted by this type of recorders, which results in the incorrect detection of numerous errors in the address data stored on the disc. As a consequence, the recorder will not start recording information on this record carrier.

The record carrier according to the invention has as a further advantage that double payment of content to be stored on the record carrier, a first time by the levy on the blank record carrier, and a second time by the secure downloading procedure, can be avoided. As this record carrier can only be recorded by a secure recorder in case of a secure application, there is no longer a need to set a levy on the blank record carrier.

In an embodiment of the record carrier according to the invention the error-protection parity bits deviate in that error-protection parity bits are being calculated using a check polynomial that deviates from the check polynomial according to the standardized format. The record carrier according to this embodiment has the advantage that by deviating in the check polynomial used, a one-to-one relation between the address data already present on a blank record carrier and the subcode addresses of the information recorded or to be recorded on the record carrier is maintained. In a preferred embodiment the standardized format is the CD-R format, and the check polynomial used is
P(X)=X¹⁴+X¹²+X¹¹+X¹⁰+X⁴+X³+X²+1.

In another embodiment the standardized format is the CD-R format, and the error-protection parity bits deviate in that not all the error-protection parity bits are inverted.

In a preferred embodiment the first ten error-protection parity bits are inverted and the last four error-protection parity bits are non-inverted. The record carrier according to this preferred embodiment has the advantage that by making this choice in the inversion of the error-protection parity bits, no error-protection data field, holding the error-protection parity bits, corresponds to an error-protection data field as defined according to the CD-R format specification.

In other preferred embodiments the address information is recorded on the record carrier by wobbling a pregroove or the address information is recorded on the record carrier as pre-pits.

The invention further relates to the device for storing information on the record carrier wherein the error-correction means are adapted for detecting the errors in the address data bits using the error-protection parity bits which deviate from the error-protection parity bits according to the standardized format.

In the following, the present invention will be described in detail with reference to the accompanying drawings, of which:

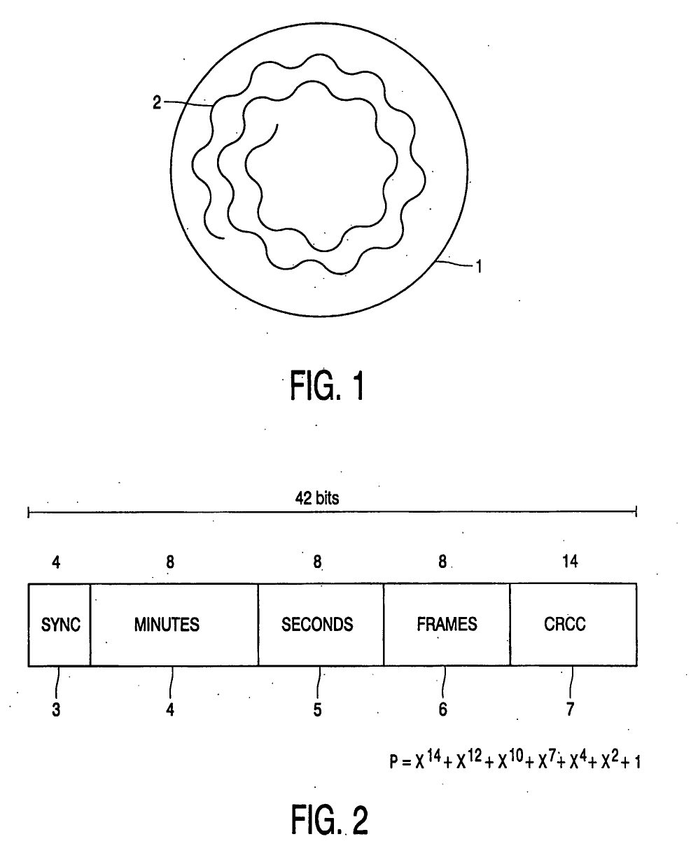

FIG. 1 shows a record carrier having a shaped groove or ridge exhibiting a periodic track modulation,

FIG. 2 shows the format of an ATIP frame on a CD-R disc,

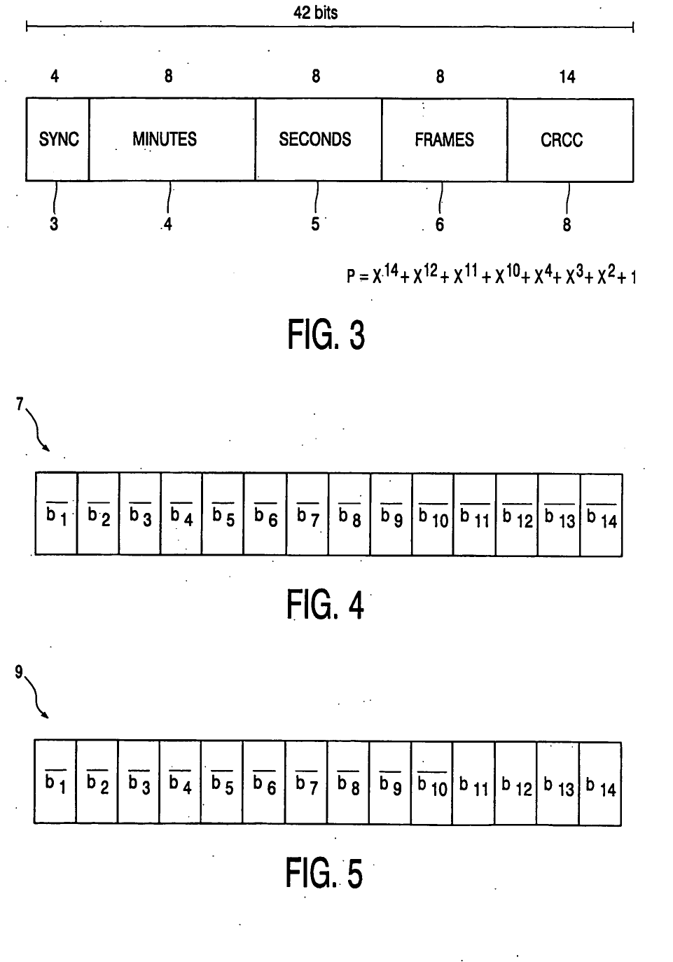

FIG. 3 shows the format of the ATIP information frame according to a first embodiment of the record carrier according to the invention,

FIG. 4 shows the CRCC field as used in a CD-R disc,

FIG. 5 shows the CRCC field according to a second embodiment of the record carrier according to the invention,

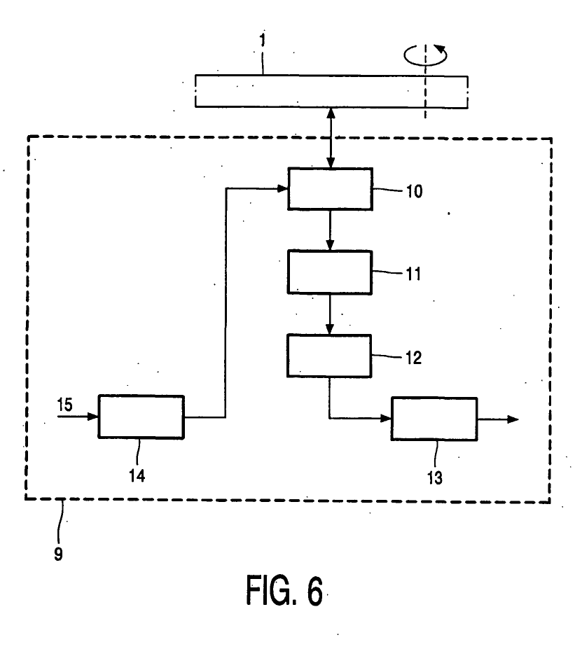

FIG. 6 shows a device for storing information on the record carrier according to the invention.

European patent application EP 0 265 984 A1(=PHN 12.063) discloses an optically readable record carrier for recording information on which address information is pre-recorded in an information-recording area. The record carrier exhibits in the information-recording area a track pattern constituting a spiral-shaped groove or ridge of constant width. This spiral-shaped groove or ridge exhibits a periodic track modulation which frequency is modulated with a digital position-information signal. The periodic track modulation in the groove is also called a groove wobble. These teachings are, among others, used in the well-known standardized CD-R discs (the specification of this record carrier is also called “The Orange Book”). This prior-art record carrier is schematically shown in FIG. 1. The record carrier 1 exhibits a track pattern comprising a spiral groove 2 of constant width provided with a radial wobble. For the sake of clarity the pitch of the spiral and the radial wobble are strongly exaggerated. In general, the pitch of the consecutive turns of the spiral path is generally of the order of magnitude of 1 to 2 μm.

Standardized CD-R discs (having a pitch of 1.6 μm) are manufactured with this groove wobble signal, which contains necessary control information for the CD recorder. The recorder uses the carrier frequency of the groove wobble to keep the spindle motor spinning at the correct speed. In CD-R the carrier frequency of the groove wobble is 22.05 kHz. The recorder uses the modulation of the carrier frequency for establishing the current location on the disc. The information stored in the modulation of the carrier frequency is known as Absolute Time in Pre-groove (ATIP) information. The ATIP information itself occurs as a 1 kHz frequency modulation of the groove wobble. The ATIP Information has the format as shown in FIG. 2. An ATIP information frame consists of 42 bits and consists of 5 parts. A Sync field 3 (4 bits), a Minutes field 4 (8 bits), a Seconds field 5 (8 bits), a Frames field 6 (8 bits) and a CRCC field 7 (14 bits). This CRCC field 7 comprises parity bits, which parity bits are used in a Cyclic Redundancy Check Code. According to the CD-R format specification, these parity bits are all inverted.

The codeword comprises the information in the Minutes, Seconds and Frames fields 4, 5 and 6 and the parity bits in the CRCC field 7. This Cyclic Redundancy Check Code (CRCC) is used for detecting errors in the information stored in these fields. The ATIP information corresponding to the fields 4, 5, 6 and 7 must be divisible by a fixed check polynomial. In the standardized CD-R disc the check polynomial used is:
P(X)=X¹⁴+X¹²+X¹⁰+X⁷+X⁴+X²+1.

As mentioned above, in CD-R, the ATIP information frame consists of 42 bits, of which 38 bits are protected by the CRC code (the Sync field is not protected). The use of the check polynomial is explained using the following example. Consider a bitstring a. This bitstream comprises the information present in the Minutes field 4, the Seconds field 5, the Frames field 6 and the CRCC field 7. The content of these fields in this example is:
Minutes field 4: 10101001
Seconds field 5: 00101000
Frames field 6: 10100100
CRCC field 7: 01010111111111
   This results in the following bitstring a:
a=10101001 00101000 1010010001001011111111
   In order to determine whether the bitstring a is a codeword according to the CD-R format specification, all parity bits are inverted, resulting in bitstring c:
c=10101001 00101000 10100100 10101000000000
   A valid codeword must be divisible by the check polynomial. This implies the following: bitstring c corresponds to a polynomial c(x). The leftmost bit of bitstring c corresponds to the coefficient of x³⁷ in c(x), the rightmost bit of bitstring c corresponds to the coefficient of x⁰. In this example this results in the following polynomial c(x):
   c(x)=x³⁷+x³⁵+x³³+x³⁰+x²⁷+x²⁵+x²¹+x¹⁹+x¹⁶+x¹³+x¹¹+x⁹
   Polynomial c(x) is dividable by the check polynomial P(x) if c(x) is a multiple of P(x). In this example this is the case is it can easily be calculated that (x²³+x⁹) P(x)=c(x). Please note that, due to the fact that the additions are modulo two, the terms x²³ in x²³ P(x) and x⁹ P(x) cancel against each other. One way of implementing the division of a polynomial c(x) by a check polynomial P(x) is by using a shift-register circuit, as is known to a skilled person, e.g. from “Theory and practice of error control codes”, Richard E. Blahut, 1983, Sections 6.2 and 6.3.

In a first embodiment of the record carrier according to the invention, a different polynomial for the CRC check is chosen. This embodiment is advantageous for the following reasons: a one-to-one relation between the ATEP addresses of the blank disc and the subcode addresses of the recorded information is maintained, it requires only minimal circuit addition in the drive IC's with respect to the available IC's, and it is possible to detect the CRC used in the ATIP information in a short time. FIG. 3 shows the format of the ATIP information frame in this embodiment. In comparison with FIG. 2, only the CRCC field is changed. CRCC field 8 contains a CRC codeword, which must be divisible by check polynomial which deviates from the check polynomial used in the CD-R format specification. It has been found that a suitable polynomial is:
P(X)=X¹⁴+X¹²+X¹¹+X¹⁰+X⁴+X³+X²+1.

As already mentioned, according to the CD-R format specification, the parity bits of the CRC codeword are all inverted. In a second embodiment of the record carrier according to the invention, only part of the parities is inverted after calculation of the polynomial. FIG. 4 shows the CRCC field as used in a standardized CD-R disc as is prescribed in the CD-R format specification. In this figure, it is shown that all bits b₁ to b₁₄ are inverted. FIG. 5 shows the CRCC field according to a second embodiment of the record carrier according to the invention. On the record carrier according to this embodiment not all parity bits are inverted, only the parity bits b₁ to b₁₄ are inverted.

It can be shown that in this second embodiment, wherein only the parity bits b₁ to b₁₄ are inverted, any word of the old code (i.e. a code word according to the CD-R format) differs in at least four positions from any code word used in the CRC code according to FIG. 5. As a consequence, even with up to 3 bit errors per ATIP frame, no record carrier according to this second embodiment can be recorded by a standard, currently available CD-R recorder, as no code word, consisting of the 38 bits protected by the CRC code, present on this record carrier corresponds to a code word as defined according to the CD-R format specification. Therefore, if the code word read out from this record carrier comprises three or less bit errors, it never passes the CRC check performed by a standard, currently available CD-R recorder. In such a case, the conventional CD-R recorder reads the ATIP frame and checks whether or not the 38 bits corresponds to a code word as defined according to the CD-R format specification. This is done by inverting the parity bits and by checking whether the code word is divisible by the check polynomial prescribed in the CD-R format specification. As the code word does not correspond to a code word as defined according to the CD-R format specification, the code word is never divisible by the check polynomial prescribed and the conventional CD-R recorder will, as a result, not start recording information on the record carrier. This second embodiment is further advantageous for the same reasons as mentioned for the first embodiment.

In a third embodiment of the record carrier according to the invention, both measures as mentioned in the first and the second embodiment are combined, i.e. only part of the parities are inverted after calculation of the polynomial and a different polynomial is chosen.

FIG. 6 shows a device for storing information on the record carrier according to the invention. This recording device 9 comprises a write head 10 of a customary type for writing information on the record carrier 1. The write head 10 can be of a customary type capable of introducing marks having detectable changes. The device further comprises an encoder 14. Signal line 15 delivers the information to be encoded to the encoder 14. After encoding, the resulting modulated binary channel signal is fed to the write head 10 for storing it on the record carrier 1. Before storing the information, the write head 10 first reads out the address information present on the record carrier. Using the address data bits comprised in the address information, the position on the record carrier where the information is to be stored can be derived.

The write head 10 can also be arranged to be able to read out information, like PCM coded audio information, present on the record carrier. After reading out the information, detection circuit 11 converts this information into a binary signal, which is applied to the error-corrector 12. The error-detector 12 is adapted for detecting errors in the address data bits using the error-protection parity bits which deviate from the error-protection parity bits according to the standardized format. After error-correction, the information is decoded in the decoder 13.

It must be noted that the present invention is not restricted to the above embodiments, but can be applied to all recordable media comprising error-protected pre-recorded address data. For example CD-RW discs or DVD+RW discs as these types of discs comprise pre-recorded address data stored in a pregroove. In stead of in a pregroove, the address data can also be stored on the record carrier in other ways, e.g. in pre-pits, as known from the standardized DVD-RAM or DVD-RW discs.

It must be noted that the term “comprises/comprising” when used in this specification, including the claims, is taken to specify the presence of stated features, integers, steps or components, but does not exclude the presence or addition of one or more other features, integers, steps, components or groups thereof. It must further be noted that the word “a” or “an” preceding an element in a claim does not exclude the presence of a plurality of such elements.

Moreover, any reference signs do not limit the scope of the claims; the invention can be implemented by means of both hardware and software, and several “means” may be represented by the same item of hardware. Furthermore, the invention resides in each and every novel feature or combination of features.

1. A record carrier (1) for storing information according to a standardized format, the record carrier comprising address information (4,5,6,8) comprising
address data bits (4,5,6) indicating a position on the record carrier, the address data bits being arranged according to the standardized format, and
error-protection parity bits (8) for detecting errors in the address data,
which deviate from the error-protection parity bits according to the standardized format.

2. A record carrier according to claim 1, wherein the error-protection parity bits (8) are being calculated using a check polynomial (P) that deviates from the check polynomial according to the standardized format.

3. A record carrier according to claim 2, wherein the standardized format is the CD-R format, and the check polynomial (P) used is
P(X)=X¹⁴+X¹²+X¹¹+X¹⁰+X⁴+X³+X²+1

4. A record carrier according to claim 1, wherein the standardized format is the CD-R format, and not all the error-protection parity bits (9) are inverted.

5. A record carrier according to claim 4, wherein the first ten error-protection parity bits are inverted and the last four error-protection parity bits are non-inverted.

6. A record carrier according to claim 1, wherein the address information (4,5,6,8) is recorded on the record carrier by wobbling a pregroove (2).

7. A record carrier according to claim 1, wherein the address information (4,5,6,8) are recorded on the record carrier as pre-pits.

8. A device (9) for storing information on the record carrier (1) according to claim 1, comprising reading means (10) for reading the address data bits (4,5,6) and the error-protection parity bits (8) present on the record carrier, error-detection means (12) for detecting errors in the address information and writing means (10) for storing information on the record carrier, wherein the error-detection means (12) are adapted for detecting the errors in the address data bits (4,5,6) using the error-protection parity bits (8) that deviate from the error-protection parity bits according to the standardized format.

9. A device according to claim 8, wherein the error-detection means (12) are adapted for detecting the errors in the address information using a check polynomial that deviates from the check polynomial according to the standardized format.

10. A device according to claim 9, wherein the standardized format is the CD-R format, and the check polynomial (P) used is
P(X)=X¹⁴+X¹²+X¹+X¹⁰+X⁴+X³+X²+1

11. A device according to claim 8, wherein the standardized format is the CD-R format, and not all the error-protection parity bits (9) are inverted.

12. A device according to claim 11, wherein the first ten error-protection parity bits are inverted and the last four error-detection data bits are non-inverted.
